(19) United States
(12) Patent Application Publication
(10) Pub. No.: US 2020/0377076 A1
(43) Pub. Date: Dec. 3, 2020

(54) POWERTRAIN CONTROL UNIT AND METHOD OF CONTROLLING THE TRANSMISSION OF A HYBRID VEHICLE

(71) Applicants: Hussein DOURRA, Bloomfield, MI (US); Jacques PROST, Heilbronn (DE); MAGNA INTERNATIONAL INC., Aurora (CA)

(72) Inventors: Hussein DOURRA, Bloomfield, MI (US); Jacques PROST, Heilbronn (DE)

(21) Appl. No.: 16/770,460

(22) PCT Filed: Dec. 18, 2018
(86) PCT No.: PCT/US2018/066222

§ 371 Date: Jun. 5, 2020

Related U.S. Application Data
(60) Provisional application No. 62/607,093, filed on Dec. 18, 2017.

(51) Int. Cl. B60W 20/40; B60W 10/02; B60W 10/10; B60W 10/06; B60W 10/08; B60W 20/13

(52) U.S. Cl. CPC B60W 20/40; B60W 10/02; B60W 10/10; B60W 2510/1005; B60W 10/08; B60W 20/13; B60W 2510/244; B60W 10/06

(57) ABSTRACT

A method of operating a dual clutch transmission of a hybrid vehicle which has an internal combustion engine and an auxiliary motor. The method includes the step of driving at least one of a first sub-transmission and a second sub-transmission with an internal combustion engine and simultaneously driving at least one of the first and second sub-transmissions with the auxiliary motor to reduce the time required to output from the dual clutch transmission a required torque.

### CROSS-REFERENCE TO RELATED APPLICATIONS

This PCT International Patent Application claims the benefit of U.S. Provisional Patent Application Ser. No. 62/607,093 filed on Dec. 18, 2017, and titled “Powertrain Control Unit And Method Of Controlling The Transmission Of A Hybrid Vehicle”, the entire disclosure of which is hereby incorporated by reference.

### BACKGROUND OF THE INVENTION

### 1. Field of the Invention

The present invention is related, generally, vehicle transmissions and, more particularly, to a control system for a dual clutch transmission in a hybrid vehicle.

### 2. Related Art

Most passenger vehicles include a powertrain that is comprised of an engine, a multi-speed transmission and a differential. The multi-speed transmission functions to permit the engine to operate through its optimum torque range over different operating conditions.

One objective of the multi-speed transmission is to increase vehicle fuel efficiency. Manual transmissions often provide better fuel economy over conventional automatic transmissions because energy is lost in the form of heat in the torque converter that is necessary for a conventional automatic transmission. However, many drivers do not want to drive a vehicle with a manual transmission, and manual transmissions require significant torque interruption during each gear shift as the engine is disengaged from the transmission so that the speeds of shafts within the transmission can be synchronized.

Another type of automatic transmission is a dual-clutch transmission, which allows for automatic shifting without the need for a torque converter. While a dual-clutch transmission may be able to shift more smoothly and with less torque interruption than a conventional manual transmission, it often takes more time to shift more than one gear at a time (for example, 5^{th} gear to 3^{rd} gear) in a dual-clutch transmission than in a conventional automatic transmission. Thus, there may be a significant lag in output when the vehicle is cruising at speed and a driver demands significant power.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a schematic view of the powertrain of a vehicle with a dual clutch transmission;

FIG. 2 is a chart showing output vs. time when skip shifting in a dual clutch transmission operating according to the control strategy of one aspect of the present invention in comparison to a conventional automatic transmission;

FIG. 3 is a flow-chart illustrating a plan for operating the powertrain shown in FIG. 1;

FIG. 4 is a table which supplements that flow-chart of FIG. 3; and

FIG. 5 is a flow-chart illustrating another plan for operating the powertrain shown in FIG. 1.

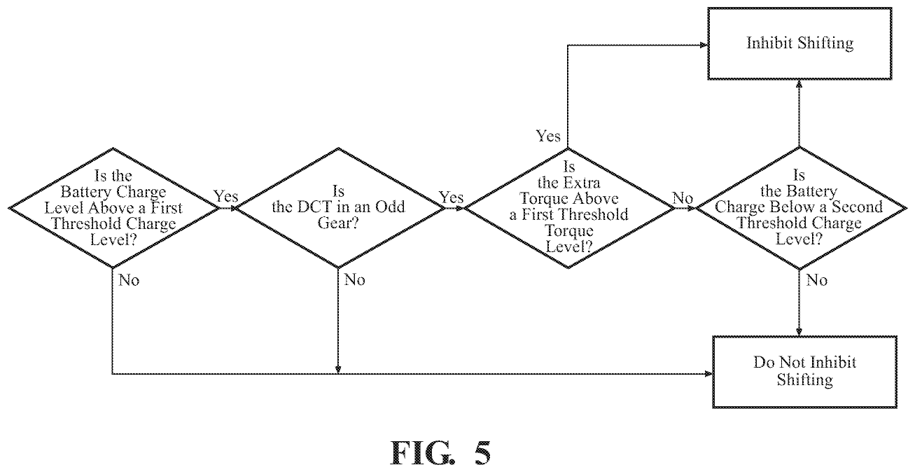

### SUMMARY OF THE INVENTION AND ADVANTAGES

One aspect of the present invention is related to a method of operating a dual clutch transmission of a hybrid vehicle which has an internal combustion engine and an auxiliary motor. The method includes the step of driving at least one of a first sub-transmission and a second sub-transmission with an internal combustion engine and simultaneously driving at least one of the first and second sub-transmissions with the auxiliary motor.

This method allows for improved performance allowing for a reduced time lag between when a driver demands additional torque and when the dual clutch transmission outputs the additional torque.

According to another aspect of the present invention, the auxiliary motor is an electric motor.

According to yet another aspect of the present invention, the electric motor is directly connected with the second sub-transmission.

According to still another aspect of the present invention, the step of driving at least one of the first and second sub-transmissions with the internal combustion engine is further defined as driving the first sub-transmission and wherein the step of simultaneously driving at least one of the first and second sub-transmissions with the electric motor is further defined as driving the second sub-transmission with the electric motor.

According to a further aspect of the present invention, the step of driving at least one of the first and second sub-transmissions with the internal combustion engine is further defined as driving the second sub-transmission with the electric motor and wherein the step of driving at least one of the first and second sub-transmissions with the electric motor is further defined as driving the second sub-transmission with the electric motor.

According to yet a further aspect of the present invention, a level of boost provided by the auxiliary motor is dependent on a state of charge of a battery.

Another aspect of the present invention is a dual clutch transmission assembly for a hybrid vehicle that includes an internal combustion engine and an electric motor. The dual clutch transmission assembly includes a first clutch that mechanically connects the internal combustion engine with a first sub-transmission. The assembly further includes a second clutch which mechanically connects the internal combustion engine with a second sub-transmission. An electric motor is mechanically connected with the second sub-transmission, and the electric motor is electrically connected with a battery. The assembly also includes a powertrain control unit which is in electrical communication with the first clutch, the first sub-transmission, the second clutch, the second sub-transmission, and the electric motor. The powertrain control unit contains a processor and a memory and is programmed to operate the first and second sub-assemblies such that the internal combustion engine drives at least one of the first and second sub-transmissions and such that the electric motor simultaneously drives the second sub-transmissions.

According to another aspect of the present invention, the first sub-transmission contains odd gears, and the second sub-transmission contains even gears.

Yet another aspect of the present invention is related to a method of operating a dual clutch transmission of a hybrid vehicle which has an internal combustion engine and an electric motor. The method includes the step of determining if an engaged gear G is an odd gear of a first sub-transmission or an even gear of a second sub-transmission. The method proceeds with preselecting gear G−1 with one of the first and second sub-transmissions. The method continues with the step of sensing a state of charge of a battery.

Still another aspect of the present invention is related to a method of operating a dual clutch transmission of a hybrid vehicle. The method includes the step of preparing a first sub-transmission and a second sub-transmission. The method continues with the step of preparing an electric motor which is mechanically connected with the second sub-transmission. The method proceeds with the step of sensing a state of charge of the battery. The method continues with the step of determining if the internal combustion engine is mechanically engaged with the first sub-transmission or with the second sub-transmission. If the state of charge of the battery is below a first threshold charge level or if the internal combustion engine is mechanically engaged with the second sub-transmission, then downshifting the dual clutch transmission. If the state of charge of the battery is above the first threshold charge level and the even gears are preselected or engaged, the extra torque demanded by the driver is greater than a threshold torque level, then the method continues with the step of inhibiting a downshift and using the electric motor to supply the extra torque demanded by the driver.

According to another aspect of the present invention, if the state of charge of the battery is between the first threshold charge level and a greater second threshold charge level; and the even gears are preselected or engaged, and the extra torque demanded by the driver is below the first threshold torque level, then the method continues with the step of inhibiting a downshift and using the electric motor to supply the extra torque demanded by the driver.

### DESCRIPTION OF THE ENABLING EMBODIMENT

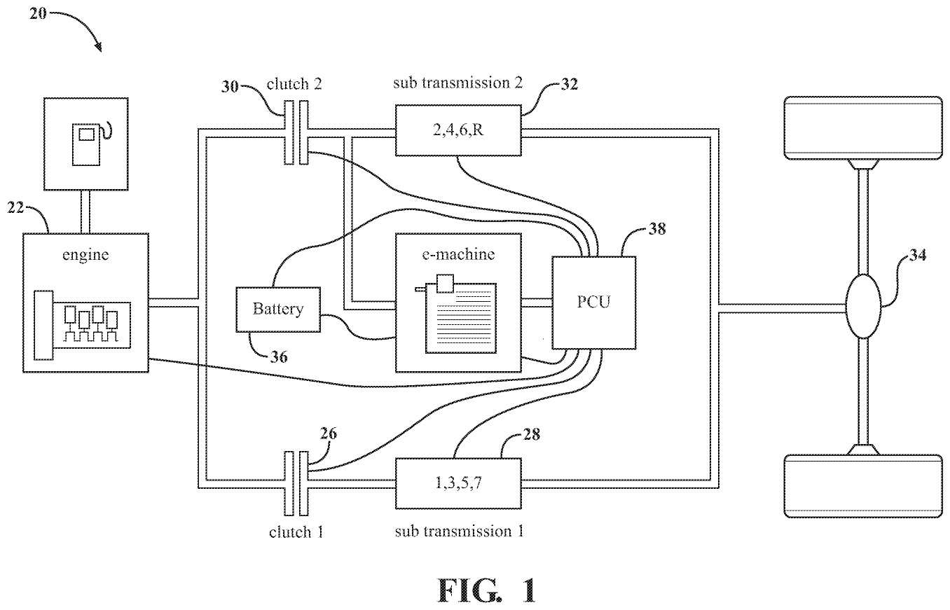

Referring to the Figures, wherein like numerals indicate corresponding parts throughout the several views, one aspect of the present invention is related to a powertrain for a hybrid vehicle and to a method of operating the powertrain of the hybrid vehicle. FIG. 1 is a schematic view of an exemplary embodiment of the powertrain 20. As shown, the powertrain 20 includes a gasoline or diesel fueled internal combustion engine 22 (ICE) and an auxiliary motor 24 which are both mechanically coupled with a dual clutch transmission. The dual clutch transmission has a first clutch 26, which is mechanically connected with a first sub-transmission 28, and a second clutch 30, which is mechanically connected with a second sub-transmission 32. During operation, selectively applying and releasing the first and second clutches 26, 30 will engage the ICE 22 with and disengage the ICE 22 from the selected gears in the first and second sub-transmissions 28, 32. Both of the sub-transmissions 28, 32 are mechanically connected with a single differential 34 which distributes torque between the vehicle's left and right driven wheels. The driven wheels could be the front wheels, the rear wheels or both the front and rear wheels in the case of all or four wheel drive. The first and second clutches 26, 30 could be wet or dry and could either be single or multi-plate. In the exemplary embodiment, the first sub-transmission 28 includes the odd gears (1, 3, 5 and 7) and is therefore referred to below as an “odd sub-transmission 28”, and the first clutch 26 is referred to below as an “odd clutch 26”. The second sub-transmission 32 includes the even gears and reverse (2, 4, 6 and R) and is therefore referred to below as an “even sub-transmission 32”, and the second clutch 28 is referred to below as an “even clutch 28”.

The auxiliary motor 24 is directly mechanically connected (such as with a gearbox, which is not shown) between the even clutch 30 and the even sub-transmission 32. This configuration allows the auxiliary motor 24 to power the even sub-transmission 32 in conjunction with or independently of the ICE 22. For example, when the odd clutch 26 is applied (i.e., closed) and the even clutch 30 is released (i.e., open) such that the ICE 22 is engaged to drive one of the odd gears of the odd sub-transmission 28, the auxiliary motor 24 can separately drive one of the even gears of the even sub-transmission 32.

In the exemplary embodiment, the auxiliary motor 24 is an electric motor 24 (e-machine) which is electrically connected with a battery 36. However, it should be appreciated that other types of auxiliary motors 24 (such as, for example, hydraulic motors) could be employed.

The ICE 22; odd and even clutches 26, 30; odd and even sub-transmissions 28, 32; the electric motor 24; and the battery 36 are all in electrical communication with a powertrain control unit (PCU) 38, also known as a powertrain control module. As discussed in further detail below, during operation of the vehicle, the PCU 38 can engage and release the clutches 26, 30; preselect gears in the sub-transmissions 28, 32; and increase or decrease the power and torque being applied by the electric motor 24 to the second sub-transmission 32. The PCU 38 includes a processor (not shown) and a memory (also, not shown) which contains a program that allows the PCU 38 to control these components of the powertrain 20 according to a control strategy discussed in further detail below.

The PCU 38 is programmed to operate the powertrain 20 in such a way that reduces torque output delays when additional torque is demanded by the driver. In some of the following description, downshifting from specific gears (e.g., 6^{th} gear to 4^{th} gear) is referenced, but it should be appreciated that it could be from any given even gear G to gear G minus one (G−1) or gear G minus two (G−2) depending on whether the downshift is a single downshift or a double downshift.

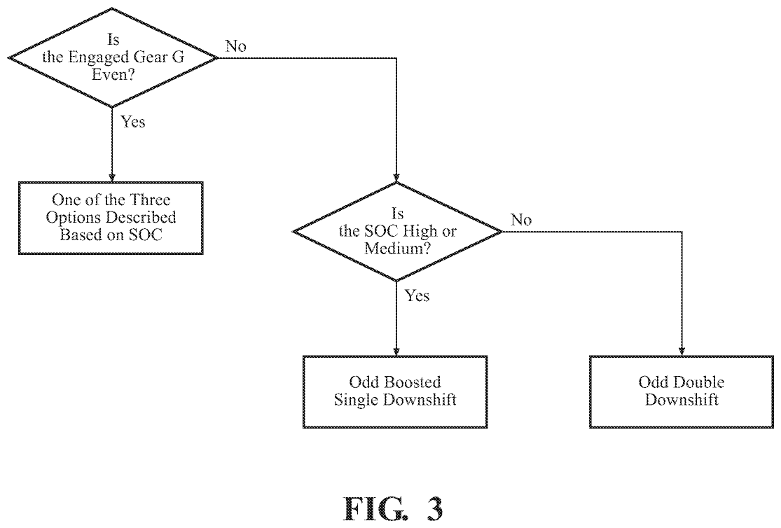

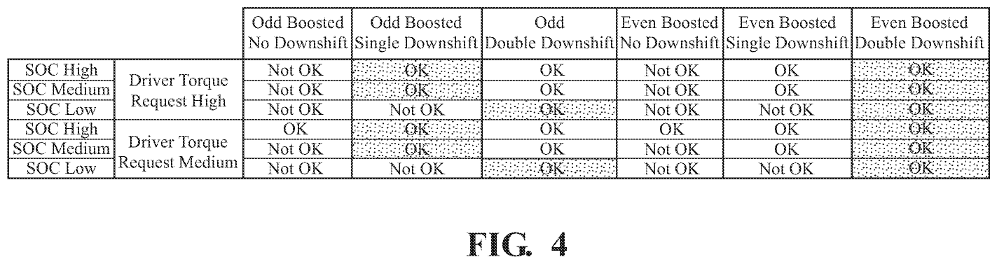

Depending on a variety of factors, several options are available to offer the driver a fast torque reaction when torque is requested. In operation, the PCU 38 analyzes a number of factors and chooses the best possible option. Those factors include whether the currently engaged gear G is even or odd, the amount of additional torque request by the driver, and the current state of charge (SOC) of the battery 36. The flow chart of FIG. 3 and the table of FIG. 4 describe various options that the PCU 38 may implement to minimize the time between when the torque is demanded and when it is provided. In the table of FIG. 4, the cells with a shaded background show a possible choice for defining the optimal shift type for each situation. As discussed below, the SOC of the battery 36 could be high (above a first predetermined threshold), medium (between first and second predetermined thresholds), or low (below the second predetermined threshold).

If the gear G that is currently engaged with the ICE 22 is an even gear, then a first option named “Even Boosted No Downshift” may be performed as described. Starting from the engaged even gear G, the even clutch 30 remains closed and the odd clutch 26 remains open while the electric motor 24 is used to boost and reach the torque requested by the driver. This option offers a fast torque reaction since the transmission stays in the same state and the electric motor 24 is used to provide the additional torque demanded. This option requires a high SOC of the battery 36 to provide a strong boost without downshifting. For this option to be implemented, the torque requested by the driver should be below a predetermined torque threshold which is based on the available torque that the electric motor 24 can provide at that instant. That is, if the torque requested by the driver is greater than the electric motor 24 is capable of providing, then the PCU 38 does not implement the “Even Boosted No Downshift” option.

If the gear G that is currently engaged with the ICE 22 is an even gear, then a second option named “Even Boosted Single Downshift” may be performed as described. Starting from the engaged even gear G, the even clutch 32 is released while the odd clutch 28 is applied to downshift the transmission from gear G to gear G−1. The electric motor 24 is activated to supply the additional torque requested by the driver. This option offers a quicker torque reaction than a double downshift since only a single downshift is performed and the electric motor 24 supplies the additional demanded torque. This option requires a medium SOC of the battery 36 to boost with a single downshift. The driver torque request can be high since the single downshift allows higher torques to be reached with the help of boosting.

If the gear G that is currently engaged with the ICE 22 is an even gear, then a third option named “Even Double Downshift” may be performed as described. Starting from the engaged even gear G, the even clutch 32 is released while the odd clutch 28 is applied. Once the even clutch 32 is open, the even sub-transmission 32 is synchronized to a lower gear (e.g., from gear 6 to gear 4). During this synchronization process, the electric motor 36 cannot provide boost torque since the even sub-transmission 32, which is connected to the electric motor 24, is not mechanically connected to the wheels. Once the even sub-transmission 32 is synchronized, the odd clutch 26 is released while the even clutch 30 is applied. This option does not offer any benefit compared to the standard double-clutch transmission because of the unavailability of the electric motor 24 as a torque source during synchronization of the even sub-transmission 32. This option does not require a specific SOC of the battery 36 since the electric motor 24 does not boost. The torque requested by the higher can be high since a double shift is performed and higher torques can be reached with only the ICE 22.

If the gear G that is currently engaged with the ICE 22 is an odd gear, then a fourth option named “Odd Boosted No Downshift” may be performed as described. Starting from the engaged odd gear G, the odd clutch 26 remains closed and the even clutch 30 remains open while the electric motor 24 is activated to boost and supply the additional torque requested by the driver. This option offers an extremely fast torque reaction since the transmission stays in the same state and the electric motor 24 is used to supply the requested torque. This option requires a high SOC of the battery 36 to strongly sufficient boost without downshifting, and the torque requested by the driver must be within the capabilities of the electric motor 24 at the present operating conditions.

If the gear G that is currently engaged with the ICE 22 is an odd gear, then a fifth option named “Odd Boosted Single Downshift” may be performed as described. Starting from the engaged odd gear G, the odd clutch 26 is released while the even clutch 30 is applied. The electric motor 24 is activated to boost and reach the additional torque requested by the driver. This option offers a quicker torque reaction as compared to a double downshift since only a single downshift is performed with the electric motor 24 is used to boost. This option requires a medium SOC of the battery 36 to boost with a single downshift. The driver torque request can be high since a single shift is performed and higher torques can be reached with the help of boosting.

If the gear G that is currently engaged with the ICE 22 is an odd gear, then a sixth option named “Odd Boosted Double Downshift” may be performed as described. Starting from an engaged odd gear G, the odd clutch 26 is released while the even clutch 30 is applied. Once the odd clutch 26 is open, the odd sub-transmission 28 is synchronized to a lower gear (e.g., from gear 7 to gear 5). In this phase, the electric motor 24 is provides a boost torque since the even sub-transmission 32, which is mechanically connected with the electric motor 24, is connected to the wheels. Once the odd sub-transmission 28 is synchronized, the even clutch 30 is released while the odd clutch 26 is applied. This option offers a fast torque reaction since the electric motor 24 is used to boost during the downshift. This option does not require a specific state of charge of the battery 36 since the electric motor 24 is only used to boost for a very short time. The driver torque request can be high since a double downshift is performed and higher torques can be reached with only the ICE.

If the state of charge of the battery 36 is above a first predetermined threshold charge level, then the method continues by driving using the electric motor 24.

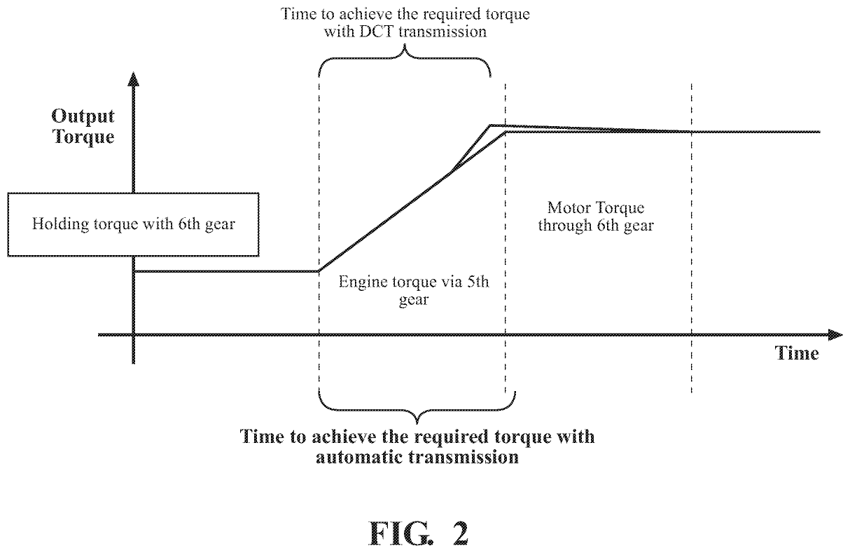

If the state of charge of the battery 36 is between the first predetermined threshold charge level and a lower second predetermined threshold charge level, then the method continues by releasing the second clutch 30 of the second sub-transmission 32 and applying the first clutch 26 of the first sub-transmission 28 and continues with driving the 5^{th} gear in the first sub-transmission 28 with the ICE 22 while providing a strong boost to 6^{th} gear in the second sub-transmission 32 with the electric motor 24. Between the ICE 22 coupled with 5^{th} gear and the electric motor 24 coupled with 6^{th} gear, the total torque output to the differential and the wheels is approximately equivalent to only the ICE 22 driving 4^{th} gear. Thus, the delay between when a driver demands torque and when the torque is actually applied is reduced as compared to the traditional control strategies for dual clutch transmissions, and as shown in FIG. 2, the delay with this control strategy has been found to be shorter than in a conventional automatic transmission.

If the state of charge of the battery 36 is below the second predetermined threshold charge level, then the electric motor 24 is not used to provide boost.

In the 2^{nd} action, the first and second clutches 26, 30 and the electric motor 24 are synchronized to provide a smooth power handoff between the first and second sub-transmissions 28, 32 and the electric motor 24. Also, the PCU 38 is programmed to control the torque split between the ICE 22 and the electric motor 24 in such a way that there is a smooth output torque gradient to the differential and the wheels.

When doing an odd-to-odd skip shift, such as 7^{th} gear to 5^{th} gear, the method begins with the first clutch 26 being initially applied, the second clutch 30 being initially released and the even gear (e.g., 6^{th} gear) between the two odd gears being preselected by the second sub-transmission 32. Next, the sensor determines the state of charge of the battery 36 which powers the electric motor. Depending on the state of charge of the battery 36 and how high of a torque capacity the even gear can handle, the PCU 38 is programmed to take one of four different actions.

If the state of charge of the battery 36 is above the first predetermined threshold charge level and the 6^{th} gear has a very high torque capacity, then the method proceeds with releasing the first clutch 26 of the first sub-transmission 28 and applying the second clutch 30 of the second sub-transmission 32 and continues driving in 6^{th} gear of the second sub-transmission 32 with the ICE 22 while also providing a strong boost with the electric motor 24 on the 6^{th} gear. The combination of the ICE 22 and the strong boost from the electric motor 24 will provide approximately an equivalent torque output to the differential and the wheels as if the ICE 22 alone was driving the 5^{th} gear. Thus, the delay between when the driver demands torque and the torque is actually applied is reduced as compared to the way dual clutch transmissions typically operate.

If the state of charge of the battery 36 is above the first predetermined threshold charge level and the 6^{th} gear has a relatively lower torque capacity, then the method proceeds with releasing the first clutch 26 of the first sub-transmission 28 and applying the second clutch 30 of the second sub-transmission 32 and continues driving in 6^{th} gear of the second sub-transmission 32 with the ICE 22 while also providing a moderate boost with the electric motor 24 on the 6^{th} gear. The method continues with the step of preselecting the fifth gear with the first sub-transmission 28. The method proceeds with simultaneously releasing the second clutch 30 and applying the first clutch 26. Next, the method continues with driving the 5^{th} gear of the first sub-transmission 28 with the ICE 22 while providing a strong boost with the electric motor 24 on the 6^{th} gear of the second sub-transmission 32. Thus, the combined torque output of the ICE 22 and the electric motor 24 provide the required output torque in 5^{th} gear.

If the state of charge of the battery 36 is between the first and (lower) second predetermined threshold charge levels, then the method proceeds with releasing the first clutch 26 of the first sub-transmission and applying the second clutch 30 of the second sub-transmission 32 and continues with driving in 6^{th} gear of the second sub-transmission 32 with the ICE 22 while providing a moderate boost with the electric motor 24 on the 6^{th} gear. The method continues with the step of preselecting the 5^{th} gear with the first sub-transmission 28. The method proceeds with simultaneously releasing the second clutch 30 and applying the first clutch 26. The method continues with the step of driving the 5^{th} gear of the first sub-transmission 28 while also providing a moderate boost with the electric motor 24 on the 6^{th} gear. The combined torque output of the ICE 22 and the electric motor 24 is higher than if only the ICE 22 was engaged with the 5^{th} gear.

If the state of charge of the battery 36 is below the second predetermined threshold charge level, then the method proceeds with releasing the first clutch 26 of the first sub-transmission and applying the second clutch 30 of the second sub-transmission 32 and continues with the step of driving the 6^{th} gear of the second sub-transmission 32 with the ICE 22 while also providing a moderate boost with the electric motor 24 on the 6^{th} gear. The method continues with the step of preselecting the 5^{th} gear with the first sub-transmission 28. The method proceeds with simultaneously releasing the second clutch 30 and applying the first clutch 26. The method continues with the step of driving the 5^{th} gear of the first sub-transmission 28. Electric motor 24 torque is only used during synchronization.

In all of the above-scenarios, if the preselected gear is not the correct gear, then the PCU 38 can slow the speed change duration to allow time to resynchronize. That is, the process is slowed down to achieve an intermediate gear until the preselected gear is in place before releasing and applying the appropriate ones of the first and second sub-transmissions 28, 32.

In addition to providing quicker torque response, the above-discussed dual clutch transmission control strategy also may improve the durability and operating life of the dual clutch transmission and can improve shift schedule and minimize shift busyness.

According to another aspect of the present invention, the PCU 38 is configured to operate the powertrain 20 in such a way that, when a driver demands additional torque by pressing the accelerator pedal, the electric motor 24 is utilized to selectively provide at least some of that extra torque to the differential 34 and, in some circumstances, the PCU 38 inhibits shifting of the dual clutch transmission to thereby reduce throttle response time.

When the driver demands extra torque, then the PCU 38 compares a state of charge of the battery 36 to a first threshold charge level. If the PCU 38 determines that the state of charge is below the first threshold charge level, then the PCU 38 does not inhibit shifting of the dual clutch transmission. In other words, if the battery's charge is below a certain level, the dual clutch transmission shifts according to the default shift schedule.

If the PCU 38 determines that the state of charge of the battery 36 is above the first threshold charge level and one of the even gears is engaged with the ICE 22 or preselected, then the PCU 38 makes further comparisons to determine if shifting should be inhibited. Specifically, the PCU 38 compares the extra torque (total torque demanded minus current torque) demanded by the driver to electric motor 24 available torque. If the PCU 38 determines that the extra torque is less than electric motor 24 available torque, then the PCU 38 simultaneously instructs the dual clutch transmission to inhibit a downshift and instructs the electric motor 24 to supply the extra torque demanded by the driver.

If the PCU 38 determines that the extra torque demanded by the driver is less than electric motor 24 available torque and the state of charge of the battery 36 is between the first threshold charge level and a second threshold charge level, then the PCU 38 simultaneously instructs the dual clutch transmission to inhibit a downshift and instructs the electric motor 24 to supply the extra torque.

The above-discussed configuration advantageously allows the powertrain to, in certain circumstances, supply additional torque to the differential 34 without shifting the dual clutch transmission. Thus, although it does not have one, in these circumstances, the powertrain operates similar to one with a continuously variable transmission (CVT) in that it supplies additional torque to the differential 34 without shifting. Accordingly, for a driver, the dual clutch transmission operated according to the shift schedule of the exemplary embodiment will shift less (less shift busy-ness) than one operated according to a conventional shift schedule.

Obviously, many modifications and variations of the present invention are possible in light of the above teachings and may be practiced otherwise than as specifically described while within the scope of the appended claims.

What is claimed is:

1. (canceled)

2. (canceled)

3. (canceled)

4. (canceled)

5. (canceled)

6. (canceled)

7. (canceled)

8. (canceled)

9. A method of operating a dual clutch transmission of a hybrid vehicle which has an internal combustion engine and an electric motor, comprising the steps of:
determining if an engaged gear G is an odd gear of a first sub-transmission or an even gear of a second sub-transmission;
pre-selecting gear G−1 with one of the first and second sub-transmissions;
sensing a state of charge of a battery;
if the engaged gear G is an even gear, then:
if the state of charge of the battery is above a first predetermined threshold, then:
driving gear G with the internal combustion engine while providing a boost to gear G with the electric motor,
if the state of charge of the battery is between the first predetermined threshold and a lower second predetermined threshold, then:
simultaneously releasing a second clutch that is associated with the second sub-transmission and applying a first clutch that is associated with the first sub-transmission, and
driving gear G−1 with the internal combustion engine while providing a boost to gear G with the electric motor,
if the state of charge of the battery is below the second predetermined threshold, then:
simultaneously releasing a second clutch that is associated with the second sub-transmission and applying a first clutch that is associated with the first sub-transmission,
driving gear G−1 with the internal combustion engine,
preselecting gear G−2,
simultaneously releasing the first clutch and applying the second clutch, and
driving gear G−2 with the internal combustion engine without a boost from the electric motor, and
if the engaged gear is an odd gear, then:
if the state of charge of the battery is above the first predetermined threshold, then:
driving gear G with the internal combustion engine while providing a boost to gear G−1 with the electric motor,
if the state of charge of the battery is between the first predetermined threshold and a lower second predetermined threshold, then:
simultaneously releasing the first clutch and applying the second clutch, and
driving gear G−1 with the internal combustion engine while providing a boost to gear G−1 with the electric motor,
if the state of charge of the battery is below the second predetermined threshold, then:
simultaneously releasing the first clutch and applying the second clutch,
driving gear G−1 with the internal combustion engine while providing a boost to gear G−1 with the electric motor,
preselecting gear G−2,
simultaneously releasing the second clutch and applying the first clutch, and
driving gear G−2 with the internal combustion engine while providing a boost to gear G−1 with the electric motor.

10. A method of operating a dual clutch transmission of a hybrid vehicle, comprising the steps of:
preparing a first sub-transmission and a second sub-transmission;
preparing an electric motor which is mechanically connected with the second sub-transmission;
determining if the internal combustion engine is mechanically engaged with the sub-transmission or with the second sub-transmission;
sensing a state of charge of the battery;
determining an amount of extra torque being demanded by a driver;
if the state of charge of the battery is below a first threshold charge level or if the internal combustion engine is mechanically engaged with the second sub-transmission, then downshifting the dual clutch transmission; and
if the state of charge of the battery is above the first threshold charge level and the internal combustion engine is mechanically engaged with the transmission and the extra torque demanded by the driver is greater than a threshold torque level, then inhibiting a downshift and using the electric motor to supply the extra torque being demanded by the driver.

11. The method as set forth in claim 10 further including the step of if the state of charge of the battery is between the first threshold charge level and a greater second threshold charge level and the internal combustion engine is mechanically engaged with the transmission and the extra torque demanded by the driver is below the first threshold torque level, then inhibiting a downshift and using the electric motor to supply the extra torque being demanded by the driver.

12. A method of operating a dual clutch transmission of a hybrid vehicle that has an internal combustion engine and an electric motor, comprising the steps of:
determining whether an engaged gear G is an odd gear of a first sub-transmission or an even gear of a second sub-transmission;
pre-selecting gear G−1 with one of the first and second sub-transmissions;
sensing a state of charge of a battery;
in response to a determination that the engaged gear G is an even gear, determining whether the state of charge of the battery is above a first predetermined threshold; and
in response to a determination that the state of charge of the battery is above the first predetermined threshold, driving gear G with the internal combustion engine while providing a boost to gear G with the electric motor.

13. The method of claim 12, further comprising, in response to a determination that the state of charge of the battery is between the first predetermined threshold and a second predetermine threshold;
simultaneously releasing a second clutch that is associated with the second sub-transmission;
applying a first clutch that is associated with the first sub-transmission; and
driving gear G−1 with the internal combustion engine while providing a boost to gear G with the electric motor.

14. The method of claim 13, wherein the second predetermined threshold is lower than the first predetermined threshold.

15. The method of claim 12, further comprising, in response to a determination that the state of charge of the battery is below the second predetermined threshold:
simultaneously releasing a second clutch that is associated with the second sub-transmission and applying a first clutch that is associated with the first sub-transmission;
driving gear G−1 with the internal combustion engine;
preselecting gear G−2;
simultaneously releasing the first clutch and applying the second clutch; and
driving gear G−2 with the internal combustion engine without a boost from the electric motor.

16. The method of claim 12, further comprising, in response to a determination that the engaged gear G is an odd gear, determining whether the state of charge of the battery is above the first predetermined threshold;
in response to a determination that the state of change of the battery is above the first predetermined threshold, driving gear G with the internal combustion engine while providing a boost to gear G−1 with the electric motor.

17. The method of claim 12, further comprising, in response to a determination that the engaged gear G is an odd gear, determining whether the state of charge of the battery is between the first predetermined threshold and a second predetermined threshold:
simultaneously releasing the first clutch and applying a second clutch associated with the second sub-transmission; and
driving gear G−1 with the internal combustion engine while providing a boost to gear G−1 with the electric motor.

18. The method of claim 12, further comprising, in response to a determination that the engaged gear G is an odd gear, determining whether the state of charge of the battery is below a second predetermined threshold that is lower than the first predetermined threshold:
simultaneously releasing the first clutch and applying a second clutch associated with the second sub-transmission;
driving gear G−1 with the internal combustion engine while providing a boost to gear G−1 with the electric motor;
preselecting gear G−2;
simultaneously releasing the second clutch and applying the first clutch; and
driving gear G−2 with the internal combustion engine while providing a boost to gear G−1 with the electric motor.
